(19) United States
(12) Patent Application Publication
(10) Pub. No.: US 2020/0398648 A1
(43) Pub. Date: Dec. 24, 2020

(54) METHOD AND APPARATUS FOR AUTOMATIC WINDOW POWER SUNSHADES DEPLOYMENT ACCORDING TO SUN POSITION

(71) Applicant: GM GLOBAL TECHNOLOGY OPERATIONS LLC, Detroit, MI (US)

(72) Inventors: Jeremie Dernotte, Rochester, MI (US); Insu Chang, Troy, MI (US); Mohammad Firouz, Ypsilanti, MI (US); Edward R. Masters, Brighton, MI (US); Zhe Li, Pudong (CN)

(73) Assignee: GM GLOBAL TECHNOLOGY OPERATIONS LLC, Detroit, MI (US)

(21) Appl. No.: 16/450,140

(22) Filed: Jun. 24, 2019

(51) Int. Cl. B60J 3/02; B60H 1/00; B60J 3/04; B60J 1/20

(52) U.S. Cl. CPC B60J 3/0286; B60J 1/2011; B60J 3/04; B60H 1/0075

(57) ABSTRACT

Methods and apparatus are provided for automatically selecting and deploying a vehicle sunshade in response to vehicle orientation and sun position to reduce vehicle cabin thermal buildup. The apparatus includes a light sensor operative to measure a light intensity, a first sunshade operative to selectively provide a first light reflective surface proximate to a first glass surface wherein the first vehicle glass surface has a first orientation, a second sunshade operative to selectively provide a second light reflective surface to a second glass surface wherein the second vehicle glass surface has a second orientation, and a processor operative to determine a vehicle orientation and a sun location in response to the vehicle orientation and to engage first sunshade in response to the sun location and the first orientation such that the first sunshade is operative to reflect light transmission through the first vehicle glass.

### INTRODUCTION

The present disclosure relates generally to a system for deploying a vehicle sunshade. More specifically, aspects of the present disclosure relate to systems, methods and devices for deploying at least one of a plurality of sunshades to reflect light transmitted thorough glass surface in response to a vehicle orientation and a sun position.

Extreme vehicle cabin temperatures resulting from solar radiation may result in vehicle damage as well as occupant injury or death. The temperature increases in the vehicle cabin are primarily resultant from solar radiation passing through the car glass surfaces, such as windows, windshields, and glass roof panels. Solar radiation passing through these glass surfaces may absorbed by materials in the cabin such as the dashboard, seats, and other interior panels and surfaces which are often dark colors and thus absorb more energy. These hot surfaces then contribute to the increased temperatures within the vehicle cabin.

Increased vehicle cabin temperatures resulting from solar radiation provide a threat to children or pets forgotten, left intentionally or trapped in a vehicle who then face the risk of a heat stroke and direct sun exposure may lead to skin damage. Additionally, with an increased amount of electronics within the vehicle and larger window surface areas degradation by the sun rays may shorten the life span of the various electronic components inside the car and the materials, such as exotic or luxury-type materials. It would be desirable to provide a robust system to address temperature increase within a vehicle cabin when it is exposed to the sun to overcome the aforementioned problems.

The above information disclosed in this background section is only for enhancement of understanding of the background of the invention and therefore it may contain information that does not form the prior art that is already known to a person of ordinary skill in the art.

### SUMMARY

Disclosed herein are human machine interface methods and systems and related control logic for provisioning computational systems, methods for making and methods for operating such systems, and motor vehicles equipped with onboard control systems. By way of example, and not limitation, there is presented various embodiments of vehicle interior temperature control and automatic window shade deployment to prevent temperature increase and vehicle damage due to solar radiation are disclosed herein.

In accordance with an aspect of the present invention an apparatus having a light sensor operative to measure a light intensity, a first sunshade operative to selectively provide a first light reflective surface proximate to a first glass surface wherein the first vehicle glass surface has a first orientation, a second sunshade operative to selectively provide a second light reflective surface to a second glass surface wherein the second vehicle glass surface has a second orientation, and a processor operative to determine a vehicle orientation and a sun location in response to the vehicle orientation and to engage first sunshade in response to the sun location and the first orientation such that the first sunshade is operative to reflect light transmission through the first vehicle glass.

In accordance with another aspect of the present invention wherein the vehicle orientation is determined in response to a global positioning system signal.

In accordance with another aspect of the present invention wherein the sun location is determined in response to a time of day, a date, and a global positioning system signal.

In accordance with another aspect of the present invention wherein the processor is operative to engage the first sunshade in response to an outside temperature being greater than a predetermined threshold temperature.

In accordance with another aspect of the present invention wherein the second sunshade is not engaged in response the sun location and the first orientation.

In accordance with another aspect of the present invention wherein the first sunshade is operative to be fully retracted from the first vehicle glass surface in response to not being engaged and fully deployed in response to being engaged.

In accordance with another aspect of the present invention wherein a detector is operative to detecting a vehicle occupant and wherein the processor is operative to engage the first sunshade in response to an occupant being detected.

In accordance with another aspect of the present invention wherein the processor is operative to engage the first sunshade in response to a vehicle cabin temperature being greater than a predetermined threshold temperature.

In accordance with another aspect of the present invention, a method including determining an orientation of a vehicle in response to a global positioning system signal, calculating a sun location of a sun relative to the vehicle orientation and a time and date, engaging a sunshade within a vehicle cabin in response to the sun location wherein the sunshade is operative to reflect sunlight through a vehicle glass surface.

In accordance with another aspect of the present invention wherein the sunshade is engaged in response to a temperature outside of the vehicle cabin exceeding a threshold value.

In accordance with another aspect of the present invention wherein the sunshade is engaged in response to a temperature inside of the vehicle cabin exceeding a threshold value.

In accordance with another aspect of the present invention wherein the sunshade is engaged in response to a detection of an occupant within the vehicle cabin.

In accordance with another aspect of the present invention wherein the sunshade is engaged in response to the vehicle being in an off condition.

In accordance with another aspect of the present invention a light sensor for determining a light level and wherein the sunshade is engaged in response to the light level exceeding a threshold intensity.

In accordance with another aspect of the present invention a light sensor for determining a light level and disengaging the sunshade in response to the light level being less than a threshold intensity.

In accordance with another aspect of the present invention a vehicle having an automatic vehicle cabin temperature control system including a temperature detector for detecting a first temperature outside of the vehicle cabin, a runs state detector for detecting a run state condition of the vehicle, a light detector for detecting a light intensity, and a processor for determining an orientation of the vehicle in response to a global positioning system signal and a sun location in response to the global positioning system signal and a time and a date, the processor further operative to engage a first sunshade located proximate to a first vehicle glass in response to the first temperature exceeding a temperature threshold value, the light intensity exceeding a light threshold value, the sun location and the vehicle orientation such that a solar radiation is reflected from the first sunshade through the first vehicle glass wherein the first vehicle glass is directly exposed to the sun.

In accordance with another aspect of the present invention wherein a second sunshade located proximate to a second vehicle glass is not engaged in response to the second vehicle glass is not directly exposed to the sun.

In accordance with another aspect of the present invention an occupancy detector for detecting a vehicle occupant and wherein the first sunshade is engaged in response to detecting the vehicle occupant.

In accordance with another aspect of the present invention an occupancy detector for detecting a vehicle occupant and wherein the first sunshade is engaged in response to not detecting the vehicle occupant.

In accordance with another aspect of the present invention an interior temperature sensor for detecting a cabin temperature and wherein the first sunshade is engaged in response to the cabin temperature exceeding a cabin temperature threshold value.

The above advantage and other advantages and features of the present disclosure will be apparent from the following detailed description of the preferred embodiments when taken in connection with the accompanying drawings.

### BRIEF DESCRIPTION OF THE DRAWINGS

The exemplary embodiments will hereinafter be described in conjunction with the following drawing figures, wherein like numerals denote like elements, and wherein:

FIG. 1 shows an application for the method and apparatus for automatic window power sunshades deployment according to sun position in a motor vehicle according to an exemplary embodiment of the present disclosure.

FIG. 2 shows a block diagram illustrating a system for automatic window power sunshades deployment according to sun position in a motor vehicle according to an exemplary embodiment of the present disclosure; and

FIG. 3 shows a flow chart illustrating a method for automatic window power sunshades deployment according to sun position in a motor vehicle according to an exemplary embodiment of the present disclosure.

FIG. 4 shows a block diagram illustrating a system for automatic window power sunshades deployment according to sun position in a motor vehicle according to another exemplary embodiment of the present disclosure; and

FIG. 5 shows a flow chart illustrating a method for automatic window power sunshades deployment according to sun position in a motor vehicle according to another exemplary embodiment of the present disclosure.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

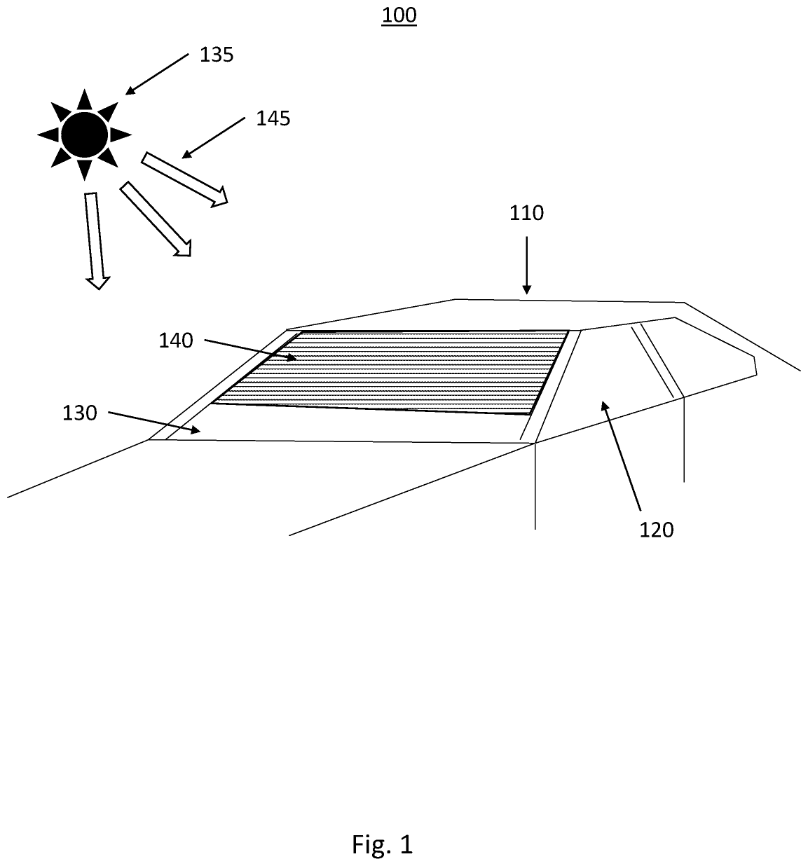

Turning now to FIG. 1, an environment for a system 100 for automatic window power sunshades deployment according to sun position in a motor vehicle according to an exemplary embodiment of the present disclosure is shown. The exemplary environment 100 includes a vehicle 110 having a first glass surface 120, such as a window, and a second glass surface 130, such as a windshield. The vehicle 110 and second glass surface 130 are in a direct path of solar radiation 145 from the sun 135. Installed within the vehicle 110 and proximate to the second glass surface 130 is a reflective shade 140 according to an exemplary embodiment of the present disclosure.

Currently, there is no robust system to address the temperature increase within a vehicle 110 when it is exposed to solar radiation 145 from the sun 135. The disclosed system helps to prevent heat-stroke from occupants, such as infants and pets, left or forgotten in a vehicle 110 and protects the vehicle interior surfaces and electronic equipment within the vehicle 110. Further, the disclosed system improves the comfort of vehicle occupants entering the vehicle 110 and reduces demand on HVAC system, particularly important for EVs, while still providing easy direct visualization into the car from the non-exposed side of the car for safety and convenience.

The exemplary method and system are operative to automatically deploy the reflective shade 140 depending on the sun 135 position relative to the vehicle 110. The system may have all glass surfaces within the vehicle 110 equipped with integrated reflective sunshades. The system is operative to reduce the temperature increase within the interior when the vehicle 110 is directly exposed to the sun. It also enables a direct visualization into the vehicle 110 from the non-exposed side for convenience, safety and to comply with potential legislation. The system is composed of power reflective sunshades integrated in the doors, along the rear and front windows, an outside temperature sensor, light sensor located on the roof near the front side of the car, a positioning system (compass and GPS) and a control unit that determines the position of the sun relative to the car. The system is operative to engage the exemplary method for a vehicle 110 that is parked, turned off, and wherein it is determined that the driver has left the vehicle. Once the temperature reaches a predetermined threshold, the method is operative to determine a sun 135 location relative to the vehicle 110 and deploy the appropriate sunshades on the exposed side of the vehicle 110.

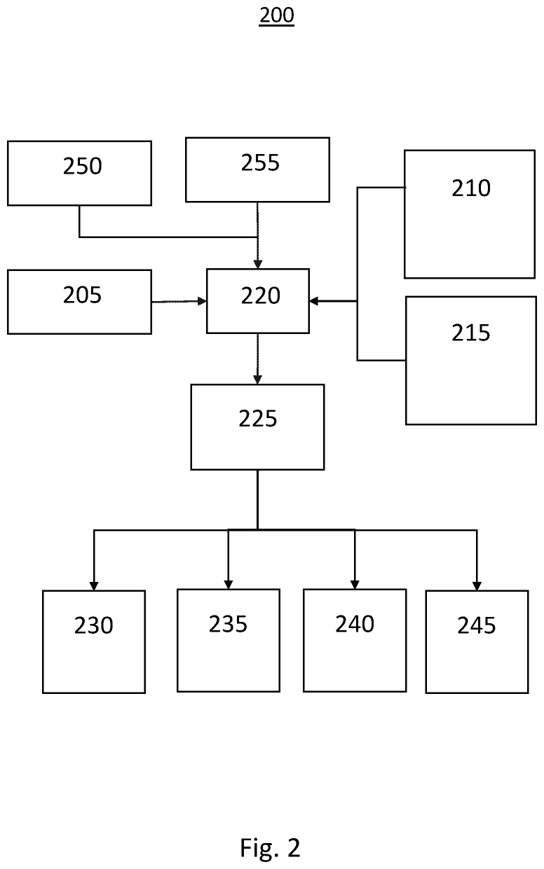

Turning now to FIG. 2, a block diagram of an exemplary system for automatic window power sunshades deployment according to sun position in a motor vehicle 200 according to an exemplary embodiment of the present disclosure is shown. The exemplary system 200 includes a light sensor 205, an exterior temperature sensor 210, an interior temperature sensor 215, a processor 220, a sunshade controller 225, a windshield sunshade 230, a right sunshade 235, a left sunshade 240 and a rear sunshade 245.

The light sensor 205, or a sun load sensor, may be a photo diode or similar device, and is used to detect light levels. The light sensor 205 may be located on a dashboard, inside a glass surface, such as the windshield, on the top of the vehicle. In an exemplary embodiment, as the sunlight intensity increases, the light sensor's signal voltage changes. This signal voltage is coupled to the processor 220 for estimating the sunlight intensity.

The exterior temperature sensor 210 is operative to generate a signal indicative of an ambient temperature outside of the vehicle. The exterior temperature sensor 210 may be a thermocouple or the like operative to generate an electrical signal in response to changes in temperature. The exterior temperature sensor 210 is located outside of the vehicle cabin and ideally not in a location subject to direct sunlight or subject to thermal radiation from other vehicle components. The electrical signal is then coupled to the processor 220 for use by the algorithm performing the disclosed methods.

Likewise, the interior temperature sensor 215 is located inside the vehicle cabin in a location not subject to direct sunlight or thermal radiation from other vehicle components. The interior temperature sensor 215 may be a thermocouple or the like operative to generate an electrical voltage indicative of the vehicle cabin internal temperature. The electrical voltage is then coupled to the processor 220 for use by the algorithm performing the disclosed methods.

The processor 220 is operative to perform the algorithm for automatic window power sunshades deployment according to sun position. The processor 220 is operative to receive the electrical signal from the exterior temperature sensor 210 to determine if the outside ambient temperature is high enough to engage the automatic window power sunshades. If the ambient temperature is high enough, the processor 220 may then be operative to receive the electrical voltage from the interior temperature sensor and determine if the vehicle cabin temperature has risen to a level high enough to engage the automatic window power sunshades. In an alternative embodiment, the automatic window power sunshade system is engaged in response to the outside temperature, irrespective of the current cabin temperature. In another alternative embodiment, the automatic window power sunshade system may be engaged in response to the absence of a driver determined in response to a signal from a seat sensor 250 located in a driver's seat.

If the processor 220 determines that the automatic window power sunshade system should be engaged, the processor 220 is then operative to determine a vehicle orientation with respect to the sun. The orientation of the vehicle relative to the sun may be determined in response to light sensor information received from the light sensor 205 or additional light sensors located at various locations around the vehicle. The orientation, or attitude, of the vehicle may be determined in response to a location signal and prior location signals from a global positioning system (GPS) 255 to determine a vehicle location and orientation. The sun location is then calculated in response to time and date information for the current location. The processor 220 is then operative to generate a control signal to couple to the sunshade controller 225 to engage the required automatic sunshades. The processor 220 may be further operative to monitor the outside temperature, interior temperature and time of day in order to disengage the automatic sunshades if they are no longer required or to engage additional or alternative sunshades at different times of day as the sun moves relative to the vehicle.

The sunshade controller 225 is operative to engage the required sunshades for the automatic window power sunshade system in response to a control signal from the processor 220. In an exemplary embodiment, a vehicle may be equipped with a windshield sunshade 230, a right sunshade 235, a left sunshade 240 and a rear sunshade 245. The control signal may be indicative of which of the various sunshades to engage, such as the windshield sunshade 230, or may be indicative of a sun location and vehicle orientation. In response to the sun location and vehicle orientation information the sunshade controller 225 may then be operative to determine which sunshades should be engaged to increased vehicle interior temperature resulting from solar radiation. The sunshade controller 225 is then operative to generate control signals to couple to the required sunshades such that the required sunshades are engaged.

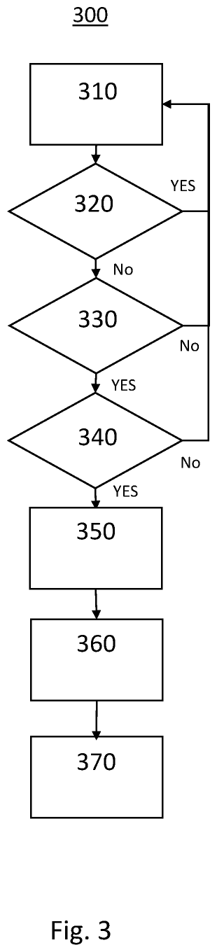

Turning now to FIG. 3, a flow chart illustrating an exemplary method for automatic window power sunshades deployment according to sun position in a motor vehicle 300 according to an exemplary embodiment of the present disclosure is shown. In this exemplary embodiment the method is first initiated in response to the vehicle being turned off 310. The vehicle being turned off may be detected by the vehicle ignition being rotated to the “off” or “lock” position. The vehicle being turned off may also be detected by monitoring the output of the alternator and detecting a zero volt output.

In addition, the method may be operative to detect 320 whether the driver is occupying the vehicle. This detection may be made in response to a gravity sensor within the driver's seat, in response to the doors being locked in response to a key fob signal, or a combination thereof. The method may be operative to use motion sensors or accelerometers within the vehicle cabin to determine if there is movement of a human or animal within the vehicle cabin.

The method is then operative to determine 330 if an outside temperature exceeds a threshold value to initiate the system. For example, if the outside temperature is less than fifty degrees Fahrenheit, the outside temperature may be low enough that any temperature increase due to solar radiation may be limited to safe levels. The temperature may be measured by a temperature sensor located outside of the vehicle cabin.

If the outside temperature exceeds a threshold value, a light sensor is used to determine light intensity 340 on the vehicle. For example, if the vehicle is parked in the shade or in a garage and is not subject to direct solar radiation, the deployment of sunshades may be ineffective to reduce vehicle cabin temperatures. This light sensor may be located on the roof of the vehicle, or on the dashboard. The existing light sensor with the vehicle cabin, used for automatic headlights, instrument lighting and the like, may be used wherein direct sunlight is estimated in response to the existing light sensor sensing light about a predetermined threshold. This predetermined threshold may be indicative of a level of sunlight, such as reflected light, incident of the vehicle sufficient enough to generate excessive cabin temperatures.

If it is determined that the light intensity exceeds a threshold value indicative of excessive solar radiation, the method is then operative to determine the orientation of the vehicle 350 with respect to the sun. The vehicle orientation may be determined in response to GPS information or compass information. The method is then operative to determine determine 360 the sun location The sun location determination may be done using a combination of: 1) light sensor information, 2) known location of the vehicle on earth using GPS, known preset position of the sun in the sky based on time/date/location, and/or a compass.

In response to a determination of the orientation of the vehicle with respect to the sun, the method is then operative to deploy the appropriate sunshades 370 to reduce cabin temperature increases resulting from solar radiation. For example, if the front of the vehicle is facing west and the time is 4:30 om, the sun is estimated to be positioned south west of the vehicle. Therefore, only the sunshades on the front window and left side of the car are deployed. The method may then be operative to return to determining if the vehicle is in the off state 310.

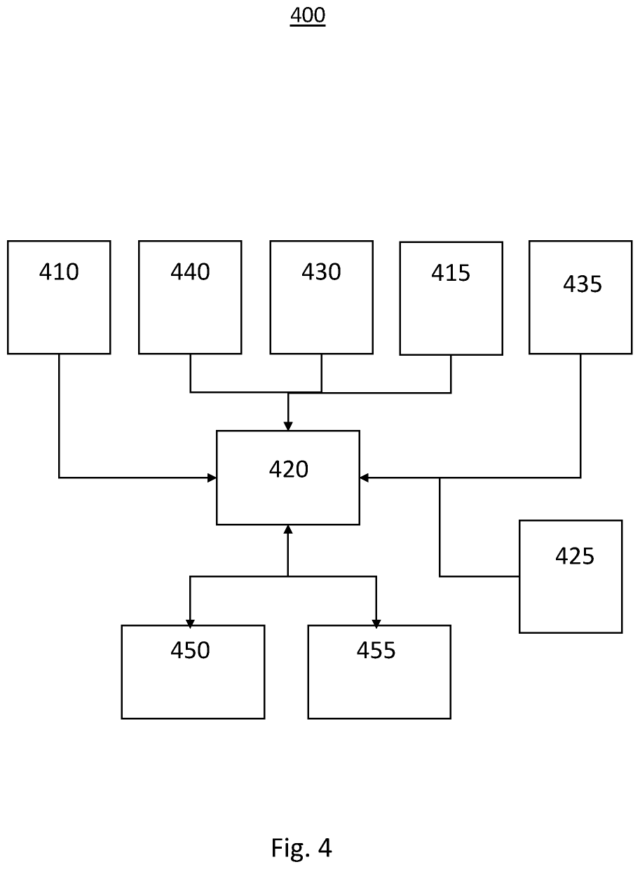

Turning now to FIG. 4, a block diagram of a system for automatic window power sunshades deployment according to sun position in a motor vehicle 400 according to an exemplary embodiment of the present disclosure is shown. The exemplary system 400 may be implemented within a vehicle as an automatic vehicle cabin temperature control system.

The exemplary system 400 includes an outside temperature detector 410 for detecting a first temperature outside of the vehicle cabin. The output from the outside temperatures detector 410 can be used to determine if the temperature outside of the vehicle is high enough to engage the automatic sunshade deployment system. For example, if the outside temperature is 30 degrees Fahrenheit, the temperature increase within the vehicle cabin due to solar radiation would not rise to a significant level to cause personal injury or vehicle damage. Therefore, the automatic sunshades would not be deployed to reflect solar radiation. The exemplary system 400 may further include an interior temperature sensor 440 operative to detect a vehicle cabin temperature. The automatic sunshades deployment system may be engaged in response to a vehicle cabin temperature raising about a certain threshold value, such as ninety degrees Fahrenheit.

The exemplary system 400 may further include a run state detector 415 for detecting a run state condition of the vehicle. The run state detector 415 may be a vehicle controller or the like and is used to determine if the vehicle is running or not. If the vehicle is running, it may not be desirable to automatically deploy the sunshades as they may block driver vision, etc. The exemplary system 400 may further include an occupancy detector 425 for determining the presence of a driver or a vehicle occupant. The occupancy detector 425 may be a motion detection device installed within the vehicle cabin or may be a seat switch or gravity detector within the seat. The occupancy detector 425 is operative to generate a signal to couple to the processor 420 indicative of the occupancy of the vehicle cabin or the corresponding vehicle seat.

The exemplary system 400 may further comprise a light detector 430 for detecting a light intensity. The light detector 430 may be installed outside of the vehicle cabin and may be operative to measure a light intensity outside of the vehicle. This light intensity could be used to determine if the vehicle is in direct sunlight and is subject to excessive interior heat buildup due to solar radiation. The light detector 430 may generate a signal indicative of a light intensity level and couple this signal to the processor 420. Alternatively, the light detector 430 may be mounted within the vehicle cabin to directly measure light intensity within the vehicle cabin. The light detector 430 may be a series of light detectors spaced throughout the vehicle cabin and wherein the light detector with the highest luminance detected could be used to determine if a vehicle cabin is subject to direct solar radiation. One of the series of light detectors may further be used to determine the location of the sun with respect to the vehicle.

The exemplary system 400 may further include a global positioning system (GPS) 435 for receiving a series of satellite signals indicative of a satellite location. The GPS 435 is then operative to determine a vehicle location in response to the series of satellite signals. The GPS 435 may be further operative to determine a vehicle orientation with respect to direction of the vehicle. For example, the GPS 435 may determine that the front of the vehicle is facing a west direction and therefore the driver's side windows have a southern exposure. The vehicle orientation may alternatively be determined in response to a compass signal from a vehicle compass.

The exemplary system 400 further includes a plurality of mechanically deploying sunshades. In this exemplary embodiment, the vehicle is equipped with a front sunshade 450 installed proximate to the vehicle windshield, and a rear sunshade 455 installed proximate to the vehicle rear window 455. The sunshades may be mounted inside the vehicle cabin such that when they are deployed, the block sunlight from entering the vehicle cabin after entering through a glass surface. For example, the front sunshade 450 may be mounted inside of the front windshield of the vehicle such that when deployed, the front sunshade 450 is operative to reflect light entering the front windshield. The front sunshade 450 may be deployed by electric motors and may be retained by slots or tracks at either side of the front windshield. Likewise, the rear sunshade 455 may be mounted proximate to the rear window in a similar manner such that light incident on the rear window is reflected back by the rear sunshade 455 and does not propagate into the vehicle cabin. Alternatively, the sunshades may be mounted outside of the vehicle cabin to prevent light from reaching the glass surfaces. Outside mounted sunshades may be retained by slots proximate to the outside of the glass surface. The system 400 is further operative to not engage a second sunshade located proximate to a second vehicle glass in response to the sun location and the vehicle orientation wherein the second vehicle glass is not directly exposed to the sun.

The exemplary system may further include a processor 420 for performing the method for automatic window power sunshades deployment. In this exemplary embodiment, the processor 420 is coupled to the exterior temperature sensor 410, the interior temperature sensor 440, the light detector 430, the run state detector 415, the GPS 435 the occupancy detector 425, the front sunshade 450 and the rear sunshade 455. The processor is first operative to determine an orientation of the vehicle in response to a location data signal from the GPS 435. The processor 420 is then operative to determine a sun location in response to the location data signal from the GPS 435 and a time and a date. The processor is then operative to determine one or more glass surfaces and corresponding sunshades within direct sunlight. The processor 420 is operative to receive data signals from the exterior temperature sensor 410, the interior temperature sensor 440, the light detector 430, the run state detector 415, and the occupancy detector 425 in order to determine if the selected sunshade should be deployed. If the processor 420 determines that the appropriate sunshade should be deployed in response to the various sensor signals, the processor 420 is then operative to deploy the appropriate sunshade such that direct sunlight is reflected out of the vehicle cabin.

The processor 420 may then be operative to engage the appropriate sunshade located proximate to a vehicle glass in response to the first temperature measurement from the external temperature sensor 410 exceeding a temperature threshold value and the light intensity measured by the light detector 430 exceeding a light threshold value. In addition, the sunshade may be deployed in response to the cabin temperature exceeding a cabin temperature threshold value. The processor 420 is then operative to control the deployment of the appropriate sunshades in response to the sun location and the vehicle orientation such that a solar radiation is reflected from the appropriate sunshade through the vehicle glass wherein the vehicle glass is directly exposed to the sun.

The occupancy detector 435 may be used for detecting a vehicle occupant and wherein the sunshade is deployed in response to detecting the vehicle occupant. For example, in the case of a child left in the vehicle, the occupancy detector may be operative to detect a rear seat occupant and wherein the sunshade is engaged in response to detecting the rear seat vehicle occupant. In addition, the sunshade may be deployed in response to the cabin temperature exceeding a cabin temperature threshold value and in response to the detection of an occupant.

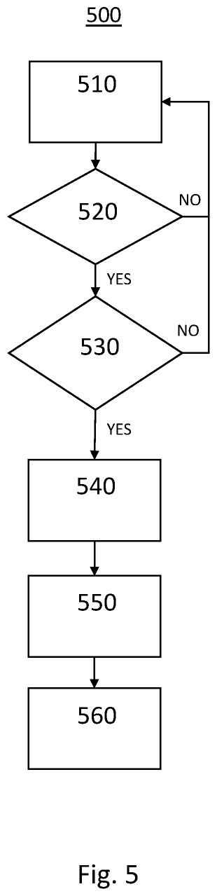

Turning now to FIG. 5, a flow chart illustrating another exemplary method for automatic window power sunshades deployment according to sun position in a motor vehicle 500 according to an exemplary embodiment of the present disclosure is shown. The method is first operative 510 to determine if the vehicle ignition is in the off position and the driver has left the vehicle. The vehicle ignition condition may be determined in response to a signal from the vehicle controller. Driver presence may be determined in response to an occupancy sensor within the vehicle cabin or may be inferred if the doors are locked with a vehicle remote. If the driver is not present and the vehicle is in the off position, the method may initiate the automatic sunshade algorithm.

The method is then operative to determine 520 if an outside temperature is above a threshold value. If the outside temperatures exceed a threshold value, such as fifty degrees Fahrenheit, the method may then be operative to determine 530 if the vehicle is directly exposed to solar radiation. The method may be operative to determine if the vehicle is directly exposed to solar radiation in response to a light sensor installed inside or outside of the vehicle cabin. Direct solar radiation may be estimated in response to a high luminance measurement from the light sensor. If the luminance level exceeds a threshold, the method may assume that the vehicle is in direct sunlight and the automatic sunshade algorithm may continue.

The method is next operative to determine an orientation of the vehicle 540 and the sun position in response to a GPS signal. The orientation of the vehicle may be determined in response to a series of chronologically received GPS signals, may be determined in response to a single GPS calculation or in response to compass data indicative of a relative direction. The sun position of the sun relative to the vehicle orientation may be determined in response to the vehicle location and the time and date.

In response to the determined sun position and the vehicle orientation, the method is then operative to determine 550 a vehicle glass surface that may be exposed to direct sunlight. For example, for a vehicle in the northern hemisphere at solar noon, a vehicle window facing south would be directly exposed to sunlight. The method is then operative to engage 560 a sunshade within a vehicle cabin in response to the sun location wherein the sunshade is operative to reflect sunlight through a vehicle glass surface wherein the vehicle glass surface is directly exposed to the sunlight.

The deployment of the sunshade engagement may be conditioned on a number of predetermined factors. For example, the sunshade may be engaged in response a temperature outside of the vehicle cabin exceeding a threshold value, to a temperature inside of the vehicle cabin exceeding a threshold value, to a detection of an occupant within the vehicle cabin, to the vehicle being in an off condition. The sunshade may be engaged in response to a signal from a light detector indicative of a light level exceeding a threshold intensity. The threshold light level may be indicative of direct sunlight. In addition the sunshade may be disengaged in response to the light level being less than a threshold intensity thereby indicating that the glass surface is no longer in direct sunlight.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus comprising:
a light sensor operative to measure a light intensity;
a first sunshade operative to selectively provide a first light reflective surface proximate to a first glass surface wherein the first vehicle glass surface has a first orientation;
a second sunshade operative to selectively provide a second light reflective surface to a second glass surface wherein the second vehicle glass surface has a second orientation; and
a processor operative to determine a vehicle orientation and a sun location in response to the vehicle orientation and to engage first sunshade in response to the sun location and the first orientation such that the first sunshade is operative to reflect light transmission through the first vehicle glass.

2. The apparatus of claim 1 wherein the vehicle orientation is determined in response to a global positioning system signal.

3. The apparatus of claim 1 wherein the sun location is determined in response to a time of day, a date, and a global positioning system signal.

4. The apparatus of claim 1 wherein the processor is operative to engage the first sunshade in response to an outside temperature being greater than a predetermined threshold temperature.

5. The apparatus of claim 1 wherein the second sunshade is not engaged in response the sun location and the first orientation.

6. The apparatus of claim 2 wherein the first sunshade is operative to be fully retracted from the first vehicle glass surface in response to not being engaged and fully deployed in response to being engaged.

7. The apparatus of claim 1 further comprising a detector for detecting a vehicle occupant and wherein the processor is operative to engage the first sunshade in response to an occupant being detected.

8. The apparatus of claim 1 wherein the processor is operative to engage the first sunshade in response to a vehicle cabin temperature being greater than a predetermined threshold temperature.

9. A method comprising:
determining an orientation of a vehicle in response to a global positioning system signal;
calculating a sun location of a sun relative to the vehicle orientation and a time and date; and
engaging a sunshade within a vehicle cabin in response to the sun location wherein the sunshade is operative to reflect sunlight through a vehicle glass surface.

10. The method of claim 9 wherein the sunshade is engaged in response to a temperature outside of the vehicle cabin exceeding a threshold value.

11. The method of claim 9 wherein the sunshade is engaged in response to a temperature inside of the vehicle cabin exceeding a threshold value.

12. The method of claim 9 wherein the sunshade is engaged in response to a detection of an occupant within the vehicle cabin.

13. The method of claim 9 wherein the sunshade is engaged in response to the vehicle being in an off condition.

14. The method of claim 9 further comprising determining a light level and wherein the sunshade is engaged in response to the light level exceeding a threshold intensity.

15. The method of claim 9 further comprising determining a light level and disengaging the sunshade in response to the light level being less than a threshold intensity.

16. A vehicle having an automatic vehicle cabin temperature control system comprising:
a temperature detector operative to detect a first temperature outside of the vehicle cabin;
a run state detector operative to detect a run state condition of the vehicle;
a light detector operative to detect a light intensity; and
a processor operative to determine an orientation of the vehicle in response to a global positioning system signal and a sun location in response to the global positioning system signal and a time and a date, the processor further operative to engage a first sunshade located proximate to a first vehicle glass in response to the first temperature exceeding a temperature threshold value, the light intensity exceeding a light threshold value, the sun location and the vehicle orientation such that a solar radiation is reflected from the first sunshade through the first vehicle glass wherein the first vehicle glass is directly exposed to the sun.

17. The vehicle having an automatic vehicle cabin temperature control system of claim 16, wherein the processor is further operative to not engage a second sunshade located proximate to a second vehicle glass in response to the sun location and the vehicle orientation when the second vehicle glass is not directly exposed to the sun.

18. The vehicle having an automatic vehicle cabin temperature control system of claim 16 further comprising an occupancy detector operative to detect a vehicle occupant and wherein the first sunshade is engaged in response to detecting the vehicle occupant.

19. The vehicle having an automatic vehicle cabin temperature control system of claim 16 further comprising an occupancy detector configured to detect a vehicle occupant and wherein the first sunshade is engaged in response to not detecting the vehicle occupant.

20. The vehicle having an automatic vehicle cabin temperature control system of claim 16 further comprising an interior temperature sensor configured to detect a cabin temperature and wherein the first sunshade is engaged in response to the cabin temperature exceeding a cabin temperature threshold value.
